(19) United States
(12) Patent Application Publication
(10) Pub. No.: US 2024/0397279 A1
(43) Pub. Date: Nov. 28, 2024

(54) SYSTEM AND METHOD FOR PRESENTING AI-GENERATED INFORMATION TO VEHICLE USER

(71) Applicant: Dr. Ing. h.c. F. Porsche Aktiengesellschaft, Stuttgart (DE)

(72) Inventors: Ethan Papp, Fremont, CA (US); Cyril Dorsaz, San Francisco, CA (US)

(73) Assignee: Dr. Ing. h.c. F. Porsche Aktiengesellschaft, Stuttgart (DE)

(21) Appl. No.: 18/201,799

(22) Filed: May 25, 2023

(51) Int. Cl. H04W 4/021

(52) U.S. Cl. CPC H04W 4/021

(57) ABSTRACT

A computer-implemented method and computer program product for presenting information about a point of interest to a user of a vehicle. The method includes the steps of: (a) determining a current location of the vehicle; (b) identifying one or more points of interest located within a pre-determined range from the current location of the vehicle; (c) using an Artificial Intelligence (“AI”) model, dynamically gathering and aggregating information about the identified points of interest; and (d) presenting to the user the information about the identified points of interest within the pre-determined range from the current location of the vehicle. The computer program is configured to perform the aforementioned steps.

### TECHNICAL FIELD

The present subject matter relates to a system and method for presenting Artificial Intelligence (AI)-generated information about a point of interest to a driver of, or a passenger in, a vehicle.

### BACKGROUND

While driving to a destination, drivers of, or passengers in, a vehicle, may encounter or be close to, without being aware of, various points of interest (POIs), such as a highly rated historic landmarks or a highly rated scenic views, for example. Drivers, and particularly passengers, especially on long journeys, may be interested in learning more about points of interest along the driving route, without much effort or distraction. Existing driving assistance systems, such as vehicle navigation systems, for example, can provide a map and directions to a specified destination, but do not offer much detail about any points of interest along the driving route. Advancements in the area of driving assistance systems are continually sought in the interests of convenience, performance, and safety. There remains a need for new driving assistance systems that can provide information about points of interest, particularly along a long driving route, thereby enhancing the in-vehicle user experience, without much effort or distractions from driving.

### SUMMARY OF INVENTION

Described herein are a method and a computer program product for presenting Artificial Intelligence (AI) generated information about a point of interest (POI) along the driving route to the driver and the passengers in the vehicle, thereby enhancing the in-vehicle experience. The method includes the steps of: (a) determining a current location of the vehicle; (b) identifying one or more points of interest within a pre-determined range from the current location of the vehicle; (c) using an Artificial Intelligence (“AI”) model, dynamically gathering and aggregating information about the identified points of interest; and (d) presenting to the user the information about the identified points of interest within the pre-determined range from the current location of the vehicle. If desired, the method can provide directions to enable the driver and the passengers to drive to and visit the presented POIs. The computer program product is configured to perform the aforementioned steps.

### BRIEF DESCRIPTION OF THE DRAWINGS

The drawing figures depict one or more implementations, by way of example only, not by way of limitations. In the figures, like reference numerals refer to the same or similar elements.

FIG. 1 depicts a schematic diagram of a vehicle and (optional) mobile device connected to the vehicle.

FIG. 2 is a flowchart depicting an overall method for presenting information about a point of interest to a user of a vehicle.

FIG. 3 is a flowchart depicting the method of FIG. 2 with additional details.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

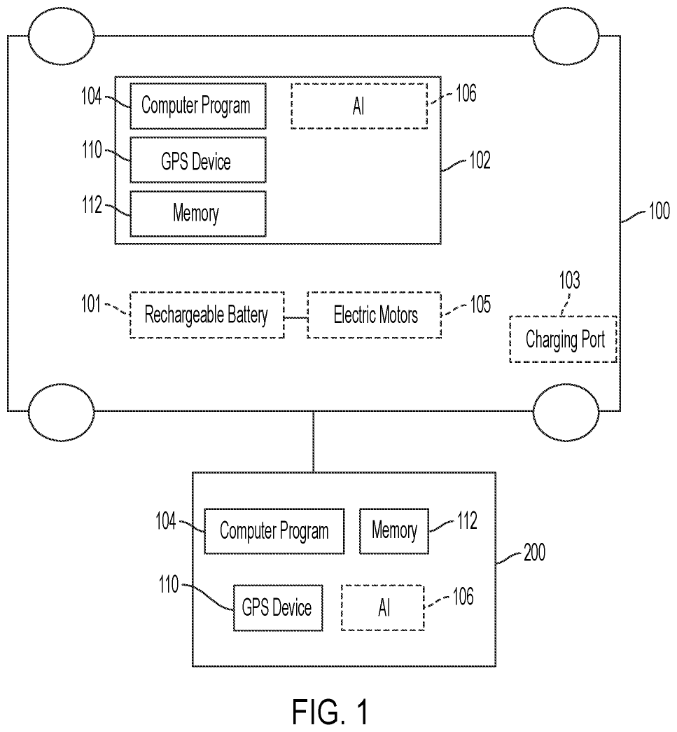

FIG. 1 depicts a vehicle 100. The vehicle 100 can be an electric vehicle having a rechargeable battery 101, a charging port 103 used for charging the battery 101, and one or more electric motors 105 receiving charge from battery 101 for driving wheels of vehicle 100. In certain embodiments, the vehicle 100 can be an autonomous driving vehicle or a semi-autonomous driving vehicle. Although FIG. 1 depicts vehicle 100 as an electric vehicle, in other embodiments, the vehicle 100 can be a standard driver-operated vehicle powered by a combustion engine that burns fuel, such as gasoline, diesel or ethanol, for example.

Regardless of the type of vehicle 100, vehicle 100 has a computer 102 for controlling operations of vehicle 100. An electronic mobile device 200 (otherwise referred to herein as a smartphone) is connected to vehicle computer 102 via a wired or wireless connection (e.g., Wi-Fi, cellular or Bluetooth connection). It is noted that components that are shown in broken lines in FIG. 1 are optional.

Vehicle computer 102 includes a processor, a visual display having means for both inputting data and displaying data (e.g., touchscreen), and a transmitter/receiver for communicating with mobile device 200 in a conventional manner. For example, vehicle computer 102 may send and receive data via Wi-Fi or 4G/LTE radios built into vehicle 100, by way of example. Mobile device 200 includes a processor, a visual display having means for both inputting data and displaying data (e.g., touchscreen), and a transmitter/receiver for communicating with vehicle 100 in a conventional manner.

A computer program 104 or a software application (e.g., “app”) is downloaded to, installed on, and stored in, either computer 102 of vehicle 100 or electronic mobile device 200 (or both). According to one embodiment, program 104 is stored within the vehicle computer 102; information can be inputted into program 104 via the display of vehicle computer 102; and information can be outputted from program 104 via the display of vehicle computer 102 (e.g., via Apple CarPlay or Android Auto). According to another embodiment, program 104 is stored within the mobile device 200; information can be inputted into program 104 via the display of mobile device 200; and information can be outputted from program 104 via the display of vehicle computer 102 (e.g., via Apple CarPlay or Android Auto). According to yet another embodiment, program 104 is a mobile application stored within the mobile device 200; information can be inputted into program 104 via the display of mobile device 200; and information can be outputted from program 104 via the display of mobile device 200. According to still another embodiment, program 104 is stored within the mobile device 200; information can be inputted into program 104 via the display of mobile device 200; and information can be outputted from program 104 via both the display of mobile device 200 and the display of vehicle computer 102.

Program 104 is connected to receive and transmit information from/to a GPS device 110 (e.g., a GPS chip) that uses the Global Positioning System (GPS). GPS device 110 is configured to determine the location of vehicle 100 or mobile device 200 within vehicle 100 in a conventional manner. GPS device 110 may form part of vehicle computer 102 or mobile device 200, or both. This locational data can be stored in memory 112. Memory 112 may also form part of vehicle computer 102 or mobile device 200, or both.

Program 104 can be designed and configured to connect directly to a third-party software applications (e.g., other “apps”) or devices via a direct connection application programming interface (API). For example, program 104 can be configured to interact with other apps installed in vehicle computer 102, such as different apps for social media, messaging, providing maps and navigation, playing music or podcasts, etc., that may be installed and be available via the display of vehicle computer 102 (e.g., via Apple CarPlay or Android Auto), for example, or with other similar apps installed on mobile device 200. In these situations, because these apps are integrated with program 104, program 104 can use each specific app's API to perform an action specified by the user.

In addition, program 104 can be configured to auto detect any smart devices (e.g., smart phones, smart watches, tablets, etc.) that are compatible with program 104 and auto connect with these devices as soon as they are setup, without the necessity for the user to set up these devices each time. As another example, program 104 can connect to a smart device via a direct connection application programming interface (API).

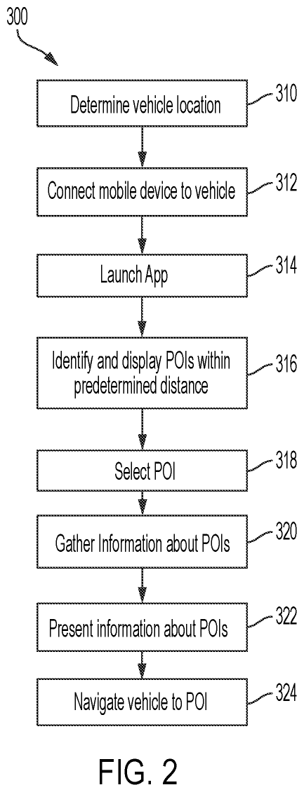

FIG. 2 is a flowchart depicting an overall method 300 for presenting information about a point of interest 500 to a user of the vehicle 100. The user of the vehicle 100 can be a driver of the vehicle 100 or a passenger in the vehicle 100. In certain embodiments, the passenger in the vehicle 100 can be a child or two or more children.

At the outset it is noted that method 300 uses mobile device 200 along with vehicle 100 to accomplish method 300, however, it should be understood that mobile device 200 may be omitted and the steps of method 300 may be completed using vehicle computer 102 of vehicle 100.

At step 310 of method 300, program 104 determines the current location of vehicle 100. Program 104 can communicate with computer 102 of vehicle 100 to gather the current position of vehicle 100, using GPS device 110, for example. It is noted that mobile device 200 may already know the position of vehicle 100 based upon the known position of mobile device 200 that is stowed in vehicle 100. The vehicle 100 may be, for example, driving to a destination or stopped at a location on its route to the destination. Step 310 may occur either prior to a vehicle trip or during the vehicle trip.

At step 312, mobile device 200 connects to vehicle 100 in either a wired or wireless manner, as described above. If the steps of method 300 are completed by vehicle 100 itself (and without the assistance of mobile device 200), then this step may be omitted. Also, step 312 does not necessarily have to follow step 310, but may be performed before step 310.

At step 314, the user (e.g., driver or passenger of vehicle 100) launches program 104 on vehicle computer 102 or mobile device 200. Step 314 may occur either prior to a vehicle trip or during the vehicle trip.

At step 316, program 104 identifies and displays one or more points of interest 500 located within a pre-determined range from the current location of the vehicle 100. The points of interest 500 can include, but are not limited to, historic landmarks, scenic views, amusement parks, or restaurants, for example. The pre-determined range (e.g., 25 miles or 10,000 meters) from the current location of the vehicle 100 may be selected by the user while the vehicle 100 is driving, or stopped during a drive to a destination, using one of the available icons in the program 104. Alternatively, the pre-determined range (e.g., 25 miles or 10,000 meters) from the current location of the vehicle 100 may be pre-programmed or saved as one of the default user settings in the program 104. For example, the pre-determined range from the current location of the vehicle 100 may be pre-programmed or saved in the program 104 as a function of the driving range of vehicle 100, based on the remaining fuel or the amount of remaining charge of an electric battery of the vehicle.

The pre-determined range from the current location of the vehicle 100 may also be associated and saved along with the saved search. The points of interest 500 may be uploaded from the Internet, a GPS program or another program (Google maps), or saved in memory 112.

Before displaying to the user the internal listing of POIs 500 generated at step 316, the listing may be sorted, arranged and organized in a certain fashion.

As one example for sorting the listing, program 104 checks the location of the POIs 500 and automatically organizes the POIs 500 such that the POIs 500 that are closest in proximity to vehicle 100 appear at the top of the list.

As another example, program 104 checks the rankings of the POIs 500 (e.g., popularity, price, user ratings, rankings, quality) and automatically organizes the POIs 500 such that the POIs 500 that are ranked highest appear at the top of the list.

At step 316, if program 104 is unable to identify any POIs 500 within the pre-determined range from the current location of the vehicle 100, then 104 program can expand the pre-determined range.

Program 104 is configured such that the user can manually sort the listing of POIs 500 (e.g., closest in proximity appears first), and/or filter the listing of POIs 500 based on one or more qualities (e.g., price, quality, user rankings, or cost of admission associated with POI 500) to match the user's preferences.

Turning back to FIG. 2, at step 318, program 104 receives from the user (e.g., driver or passenger) of the vehicle 100 user input selecting a point of interest 500 among the identified points of interest 500 that were displayed to the user at step 316. The user input can be in the form of the user selecting an icon or pressing a button on the touchscreen of vehicle computer 102. Alternatively, the user input can be in the form of a voice command by the user over an audio system of the vehicle 100.

According to this embodiment, the user selection is accomplished using the input device (e.g., touch screen, stylus, mouse pad, keyboard, etc.) of vehicle 100, however, it should be understood that the selection could be accomplished using the input device (e.g., touch screen) of mobile device 200. The user's selection can be saved in memory 112 of vehicle computer 102 or mobile device 200 for either current use or later use. The user's selection saved in memory 112 is made available for use by program 104. It should be understood that vehicle computer 102 or mobile device 200 do not (necessarily) perform the identification of one or more points of interest 500 located within a pre-determined range from the current location of the vehicle 100 at this stage. Once saved, the saved identified points of interest 500 may be presented to the user as selectable icons (e.g., icons named “Home.” “Work.” “Fun Sports Drive,” “Theater,” etc.), for example, on the display of vehicle computer 102 or mobile device 200. Each icon may be in the form of a single softkey button on the display.

In certain embodiments, program 104 can receive from the user (e.g., driver or passenger) of the vehicle 100 user input selecting a category or a type of the points of interest 500 that the user is interested in exploring, such as nature, history, entertainment, food, etc., for example. Once a category or a type of POI 500 is selected, the search may be a web-based search using Google or Google maps, or Apple maps, for example.

Program 104 can also receive from the user (e.g., driver or passenger) of the vehicle 100 additional user input further limiting the search queries for points of interest 500. For example, as part the inquiry, the user can add a randomness component into the inquiry response, such as the purpose of the inquiry, e.g., “with the goal to”: “learn something new”, “make me laugh”, “be informed”, “be surprised”, “tell me a fairytale”, “child story”, etc.

At step 320, program 104 uses an Artificial Intelligence (“AI”) model, including but not limited to AI techniques, AI algorithms, and/or AI chatbots, such as ChatGPT, for example, to dynamically gather and aggregate information about the selected point of interest 500, as the vehicle 100 travels to its destination.

In certain embodiments, the AI model can be a chatbot, such as ChatGPT, for example, running as a third-party software application (e.g., “app”) 106 on vehicle computer 102 or on the mobile device 200 of the user of the vehicle 100. Program 104 can be configured to interact with the AI or ChatGPT app 106 and use ChatGPT's API to perform an action (e.g., query) specified by the user.

In other embodiments, the AI model can be a different AI-enabled software application 106 running on vehicle computer 102 or on the mobile device 200 of the user of the vehicle 100. Program 104 can be configured to interact with the AI-enabled software application 106 and use the specific AI-enabled application's API to perform an action (e.g., query) specified by the user.

Turning back to step 320 in FIG. 2, the information about the selected point of interest 500 may include historic or interesting facts, geographic information, stories associated with highly rated historic landmarks or scenic views, famous people associated with the selected points of interest 500, etc. The information regarding the points of interest 500 is gathered, by the AI model or ChatGPT, dynamically in the sense that it is gathered, populated, and updated in real-time, as the vehicle 100 travels to its destination. As a result, the information regarding the points of interest 500 can include, but is not limited to, updates regarding the selected point of interest 500 (e.g., working hours, current promotions, nearby construction, accidents, new user reviews, etc.), so that the end user can learn more and, if desired, conveniently visit a point of interest 500 while the vehicle is driving, or has stopped, on its way, to a destination.

At step 322, program 104 presents the information about the selected point of interest 500 to the user of the vehicle 100 (e.g., driver, passengers). For example, the information about the identified points of interest 500 can be presented to the user via a Text-to-Speech (“TTS”) technology over the audio system of the vehicle 100. Step 322 of presenting to the user the information about the selected point of interest 500 can include, for example, telling a story about the selected point of interest 500. The information about the identified points of interest 500 is contextually relevant in-vehicle information and contextually local POI information, enriched by the AI model, for the audience in the vehicle (e.g., driver, passengers). For example, if there is a 57 miles of range left to the destination of the vehicle, the AI model or ChatGPT can provide interesting facts about the next 57 miles, etc. The presentation about the points of interest 500 can be interactive in the sense of allowing the user(s) of the vehicle 100 to ask questions or hear more stories about an identified point of interest 500.

In certain embodiments, program 104 can receive from the user of the vehicle (e.g., driver, passengers) user input selecting at least one of a voice, a voice tone, or a vocal timbre for telling the story about the selected point of interest 500 within the pre-determined range from the current location of the vehicle 100. For example, the user can select from different available voices that are predefined and pre-programmed in the program 104, such as male or female voices, voices of famous news broadcasters, or distinguished and well-known voices of various celebrities, for example. The tone of the voice can be selected from predefined and pre-programmed in the program 104 voice tones, such as the tone of a tour guide, broadcaster's or kindergarten or school teacher's tone, voice tones of children or young adults, or tones of older adults, such as a grandmother or a grandfather, for example.

In certain embodiments, program 104 can receive from the user of the vehicle (e.g., driver, passengers) user input selecting whether the story associated with the selected point of interest 500 should be a short story or a long story, or whether the story content should be appropriate for a child, a young adult, or for an adult listener.

At step 324, program 104 presents to the user directions for navigating the vehicle 100 to the selected point of interest 500 within the pre-determined range from the current location of the vehicle 100. The navigating the vehicle 100 to the selected point of interest 500 in step 324 can be performed by presenting directions to the user for driving the vehicle 100 to the selected point of interest 500. Alternatively, the navigating the vehicle 100 to the selected point of interest 500 in step 324 can be performed by self-driving the vehicle to the selected point of interest 500.

It is noted that steps 316 and 320 through 324 may be performed by the AI model or ChatGPT to simplify the required processing by program 104.

It should be understood that method 300 is not limited to any particular step or sequence of steps.

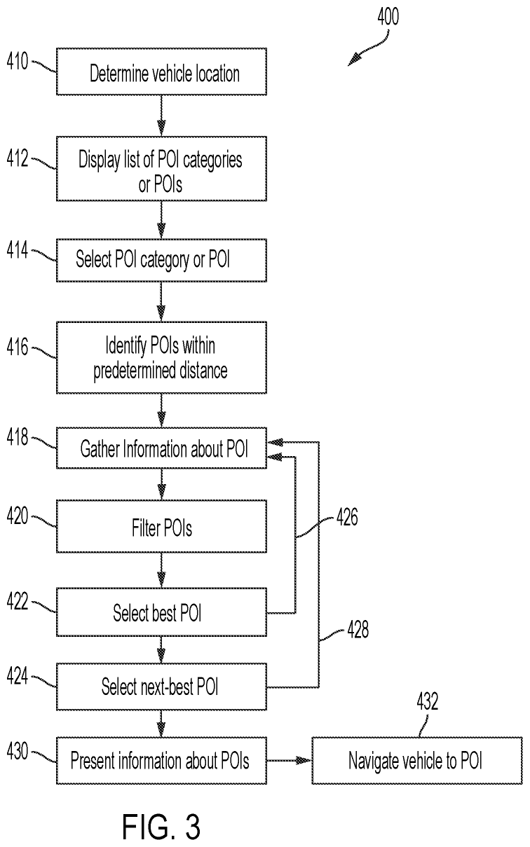

FIG. 3 is a flowchart depicting a method 400 for presenting information about a point of interest 500 to a user of the vehicle 100. Method 400 is similar to method 300 depicted in FIG. 2, but expands on method 300 by performing additional steps. Although some of the steps of the method 300 of FIG. 2, such as connecting mobile device 200 to vehicle 100 (step 312), launching program 104 on vehicle computer 102 or mobile device 200 (step 314) are omitted in FIG. 3 for the sake of clarity and brevity, these steps are still performed, at an initial point, of the method 400.

Turning back to FIG. 3, at step 410 of method 400, program 104 determines the current location of vehicle 100. Program 104 can communicate with computer 102 of vehicle 100 to gather the current position of vehicle 100, using GPS device 110, for example. It is noted that mobile device 200 may already know the position of vehicle 100 based upon the known position of mobile device 200 that is stowed in vehicle 100. The vehicle 100 may be, for example, driving to a destination or stopped at a location on the route to the destination. Step 410 may occur either prior to a vehicle trip or during the vehicle trip.

At step 412, program 104 displays a list of points of interest 500 grouped in POI categories using a list of available icons in program 104. The POI categories can include but are not limited to historic landmarks, scenic views, amusement parks, or restaurants, for example. The POI categories can include predefined (in the mobile app or in vehicle computer 102) POI categories or manually defined, by the user, (in the mobile app or in vehicle computer 102) POI categories. The POI categories and the points of interest 500 grouped within the POI categories may be indicated as separate POI icons in program 104, allowing the user to select one of the icons designating, with a name or a brief description, a specific POI category or a specific points of interest 500.

At step 414, program 104 receives from the user (e.g., driver or passenger) of the vehicle 100 user input selecting a POI category or a point of interest 500 among the identified POI categories or points of interest 500 that were presented to the user at step 414. The user input can be in the form of the user selecting an icon or pressing a button on the touchscreen of vehicle computer 102. Alternatively, the user input can be in the form of a voice command by the user over an audio system of the vehicle.

According to this embodiment, the user selection is accomplished using the input device (e.g., touch screen, stylus, mouse pad, keyboard, etc.) of vehicle 100, however, it should be understood that the selection could be accomplished using the input device (e.g., touch screen) of mobile device 200. The user's selection can be saved in memory 112 of vehicle computer 102 or mobile device 200 for either current use or later use. The user's selection saved in memory 112 is made available for use by program 104. It should be understood that vehicle computer 102 or mobile device 200 do not (necessarily) perform the identification of one or more points of interest 500 located within a pre-determined range from the current location of the vehicle 100 at this stage. Once saved, the saved identified points of interest 500 may be presented to the user as selectable icons (e.g., icons named “Home.” “Work,” “Theater,” etc.), for example, on the display of vehicle computer 102 or mobile device 200. Each icon may be in the form of a single softkey button on the display.

At step 416, program 104 recursively searches for, and identifies, relevant points of interest 500 (e.g., historic landmarks, scenic views, etc.) that match the selected POI category icon within a pre-determined range (e.g., 50 miles) from the current location of vehicle 100. The points of interest 500 can include but are not limited to historic landmarks, scenic views, amusement parks, or restaurants, for example. The pre-determined range (e.g., 25 miles or 10,000 meters) from the current location of the vehicle 100 may be selected by the user while the vehicle 100 is driving, or stopped during a drive to a destination, using one of the available icons in the program 104. Alternatively, the pre-determined range (e.g., 25 miles or 10,000 meters) from the current location of the vehicle 100 may be pre-programmed or saved as one of the user settings in the program 104. The pre-determined range from the location of the vehicle 100 may also be associated and saved along with the saved search. The points of interest 500 may be uploaded from the Internet, a GPS program or another program (Google maps) or saved in memory 112.

At step 418, program 104 uses an Artificial Intelligence (“AI”) model, including but not limited to AI techniques, AI algorithms, and/or AI chatbots, such as ChatGPT, for example, to dynamically gather and aggregate information about the selected points of interest 500 in step 414, as the vehicle 100 travels to its destination. The information about the selected points of interest 500 may include historic or interesting facts, geographic information, stories associated with highly rated historic landmarks or scenic views, famous people associated with the selected points of interest 500, user reviews, etc. The information regarding the points of interest 500 is gathered, by the AI model or ChatGPT, dynamically in the sense that it is gathered, populated, and updated in real-time, as the vehicle 100 travels to its destination. As a result, the information regarding the points of interest 500 can include, but is not limited to, updates regarding the selected point of interest 500 (e.g., working hours, current promotions, nearby construction, accidents, new user reviews, etc.), so that the end user can learn more and, if desired, conveniently visit a point of interest 500 while the vehicle is driving, or has stopped, on its way, to a destination.

At step 420, program 104 filters the selected points of interest 500 that match the selected POI category icon within a pre-determined range (e.g., 50 miles) from the current location of vehicle 100 at step 416. More particularly, program 104 is configured to filter the selected points of interest 500 that match the selected POI category to identify to the user the most highly relevant POIs 500 based upon user settings (e.g., user ratings, quality, rating value, admission price, etc.) and/or crowd-sourced data (e.g., popularity, user ratings, rankings, quality, rating value, admission price). The filters may be set by the user in program 104. POIs 500 that do not meet one or more qualifications or standards are (optionally) filtered out of the listing.

At step 422, program 104 selects a best result among the filtered points of interest 500 in step 420 based on rating count and the rating value. For example, the “best” result among the filtered points of interest 500 can be a highest rated point of interest 500 (e.g., with “good” ratings) or the highest rated point of interest 500 with a number of user reviews greater than a predetermined threshold.

At step 424, program 104 can select a next-best (e.g., second best) result among the filtered points of interest 500 based on rating count and the rating value. For example, the “next-best” result among the filtered points of interest 500 can be a next-highest (or the second-highest) rated point of interest 500 (e.g., with “good” ratings) or the next-highest (or the second-highest) rated point of interest 500 with a number of user reviews greater than a predetermined threshold. That way, once the “best” result among the filtered points of interest 500 is presented to the user of the vehicle, if the user wishes to learn more about the surroundings of the vehicle 100, program 104 can provide to the user of the vehicle information about the next-highest rated point of interest 500, without duplicating previously provided information. The program 104 can continue to select further next-highest rated points of interest 500 until no more points of interest 500 remain with a number of “good” ratings greater than the predetermined threshold.

At step 426, program 104 sends the best POI result selected from the filtered points of interest at step 422 to the AI model or ChatGPT with a request for additional information and/or updates about the best POI result among the filtered points of interest within the pre-determined range from the location of the vehicle 100. That way, program 104 continuously selects the current highest rated POI with a number of users reviews greater than a predetermined threshold to be used by the AI model or ChatGPT in answering subsequent queries by the user of the vehicle 100.

Likewise, at step 428, program 104 can send the next-best POI result selected from the filtered points of interest at step 424 to the AI model or ChatGPT with a request for additional information and/or updates about the next-best POI result among the filtered points of interest within the pre-determined range from the location of the vehicle 100. That way, program 104 continuously selects the current next highest rated POI with a minimum number of users reviews greater than the predetermined threshold to be used by the AI model or ChatGPT in answering subsequent queries by the user of the vehicle 100.

At step 430, program 104 presents to the user the information about the selected points of interest 500 within the pre-determined range from the current location of the vehicle 100. For example, the information about the selected points of interest 500 can be presented to the user via a Text-to-Speech (“TTS”) technology over the audio system of the vehicle 100. Step 430 of presenting to the user the information about the selected points of interest 500 within the pre-determined range from the current location of the vehicle 100 can include, for example, telling a story about the selected points of interest 500. The information about the selected points of interest 500 is contextually relevant in-vehicle information and contextually local POI information, enriched by the AI model, for the audience in the vehicle (e.g., driver, passengers). For example, if there is a 57 miles of range left to the destination of the vehicle, the AI model or ChatGPT can provide interesting facts about the next 57 miles, etc. The presentation about the points of interest 500 can be interactive in the sense of allowing the user(s) of the vehicle 100 to ask questions or hear more stories about an identified point of interest 500.

In certain embodiments, program 104 can receive from the user of the vehicle (e.g., driver, passengers) user input selecting at least one of a voice, a voice tone, or a vocal timbre for telling the story about the selected point of interest 500 within the pre-determined range from the current location of the vehicle 100. For example, the user can select from different available voices that are predefined and pre-programmed in the program 104, such as male or female voices, voices of famous news broadcasters, or distinguished and well-known voices of various celebrities, for example. The tone of the voice can be selected from predefined and pre-programmed in the program 104 voice tones, such as the tone of a tour guide, broadcaster's or kindergarten or school teacher's tone, voice tones of children or young adults, or tones of older adults, such as a grandmother or a grandfather, for example.

In certain embodiments, program 104 can receive from the user of the vehicle (e.g., driver, passengers) user input selecting whether the story associated with the selected point of interest 500 should be a short story or a long story, or whether the story content should be appropriate for a child, a young adult, or for an adult listener.

At step 432, program 104 presents to the user directions for navigating the vehicle 100 to the selected point of interest 500 within the pre-determined range from the current location of the vehicle 100. The navigating the vehicle 100 to the selected point of interest 500 in step 432 can be performed by presenting directions to the user for driving the vehicle 100 to the selected point of interest 500. Alternatively, the navigating the vehicle 100 to the selected point of interest 500 in step 432 can be performed by self-driving the vehicle to the selected point of interest 500.

It is noted that steps 416 through 428 may be performed by the AI model or ChatGPT to simplify the required processing by program 104.

It should be understood that method 400 is not limited to any particular step or sequence of steps.

Nor are methods 300 and 400 limited to the particular queries described herein. For example, the methods 300 and 400 can be applied in a similar manner to obtain additional information from an AI-based model, such as ChatGPT, for example, and provide this additional information to the user of vehicle 100 about anything related to the in-vehicle user's experience, such as a current street the vehicle 100 is driving on, the current city or area the vehicle 100 is driving through, currently playing music, news, or podcasts, etc. The obtained information can be conveniently presented to the user via text-to-speech technology, using Apple CarPlay, Android Auto, Microsoft SYNC, or over the vehicle audio system, for example. In other words, the steps of methods 300 and 400 can be used to enhance the in-vehicle user's experience with any of the vehicle systems or software apps that are installed and running on vehicle's computer or on a mobile device connected to vehicle 100.

As another example, the methods 300 and 400 can be applied in a similar manner to obtain additional information from an AI-based model, such as ChatGPT, for example, and provide this additional information to the user of vehicle 100 about the vehicle's efficiency or the user's driving habits. For example, program 104 can include an icon or a button titled “How is my Driving?” Pressing this icon or button by the user of the vehicle 100 can obtain information from the vehicle 100 related to current consumption (e.g., electric or gasoline) data. The user can then ask the AI model or ChatGPT: “Tell me some information about my vehicle consumption” in miles per gallon (mpg) or kilowatt-hour per 100 miles (kwh/100 mi), depending on whether the vehicle 100 is an electric or a gasoline vehicle. This exchange can lead to some fun and entertainment for the user of the vehicle and can provide contextually relevant and interesting in-vehicle data, enriched by the AI model, for the audience in the vehicle (e.g., driver, passengers), with relevant prompts (e.g. “Tell me some information about . . . ”). In addition, the response from the AI model or ChatGPT can be different most of the time because it is based on real-time vehicle data.

Also, although it has been described that program 104 on vehicle computer 102 performs the steps described herein, it should be understood that program 104 on mobile device 200 may perform these steps in lieu of vehicle computer 102.

It is noted that the prior art may disclose methods for locating points of interest along a driving route, however, the method described herein is directed to receiving a desired category of points of interest from a user, finding a point of interest related to the category of interest within a near proximity to the vehicle as the vehicle is driving toward a destination, and using an AI model or ChatGPT, dynamically gathering, populating, and presenting additional information regarding the point of interest in real-time, as well as any updates regarding the point of interest (working hours, current promotions, construction, accidents, new user reviews, etc.), so that the end user can obtain information about, and conveniently visit, a point of interest while the vehicle is driving, or has stopped on its way, to a destination.

In the context of the present description, the functions of the artificial intelligence (AI) model may be carried out by a processor. The processor can be understood to mean a machine or an electronic circuit, for example. In particular, a processor can be a central processing unit (CPU), a microprocessor or microcontroller, for example an application-specific integrated circuit or digital signal processor, possibly in combination with a data storage unit for storing program commands, etc. Additionally, a processor can be understood to be a virtual processor, a virtual machine or soft CPU. The AI model may be a program that is stored in the memory of the machine.

It will be understood that the operational steps are performed by the computers or processors described herein upon loading and executing software code or instructions which are tangibly stored on a tangible, non-transitory computer readable storage medium, such as on a magnetic medium, e.g., a computer hard drive, an optical medium, e.g., an optical disc, solid-state memory, e.g., flash memory, or other storage media known in the art. Thus, any of the functionality performed by the computers or processors described herein described herein is implemented in software code or instructions which are tangibly stored on a tangible, non-transitory computer readable storage medium. Upon loading and executing such software code or instructions by the computers or processors, the computers or processors may perform any of the functionality of the computers or processors described herein, including any steps of the methods described herein.

The term “software code” or “code” used herein refers to any instructions or set of instructions that influence the operation of computers or processors. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

It will also be understood that the terms and expressions used herein have the ordinary meaning as is accorded to such terms and expressions with respect to their corresponding respective areas of inquiry and study except where specific meanings have otherwise been set forth herein. The terms “comprises,” “comprising,” “includes,” “including,” or any other variation thereof, are intended to cover a non-exclusive inclusion, such that a process, method, article, or apparatus that has, comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A computer-implemented method for presenting information about a point of interest to a user of a vehicle, said method comprising the steps of:
(a) determining a current location of the vehicle;
(b) identifying one or more points of interest located within a pre-determined range from the current location of the vehicle;
(c) using an Artificial Intelligence (“AI”) model, dynamically gathering and aggregating information about the identified points of interest; and
(d) presenting to the user the information about the identified points of interest within the pre-determined range from the current location of the vehicle.

2. The computer-implemented method of claim 1, wherein the AI model comprises a chatbot.

3. The computer-implemented method of claim 1, further comprising a step (e) of filtering the identified points of interest by rating count and rating value before the step (c) of dynamically gathering and aggregating information about the identified points of interest.

4. The computer-implemented method of claim 3, further comprising a step (f) of selecting a best result among the filtered points of interest based on the rating count and the rating value, wherein the best result among the filtered points of interest is a highest rated point of interest with a number of user reviews greater than a predetermined threshold.

5. The computer-implemented method of claim 4, further comprising a step (g) of selecting a next-best result among the filtered points of interest based on the rating count and the rating value, wherein the next-best result among the filtered points of interest is a next-highest rated point of interest with a minimum number of user reviews greater than the predetermined threshold.

6. The computer-implemented method of claim 5, further comprising a step (h) of sending the best result from the filtered points of interest to the AI model with a request for additional information about the best result among the filtered points of interest within the pre-determined range from the location of the vehicle.

7. The computer-implemented method of claim 1, further comprising a step (i) of receiving from the user a user input selecting a point of interest among the identified points of interest that were presented to the user at step (d).

8. The computer-implemented method of claim 7, wherein the user input comprises a pressing of a button on a display screen of a vehicle driving assisting system or a voice command over an audio system of the vehicle.

9. The computer-implemented method of claim 7, wherein the step (d) of presenting to the user the information about the identified points of interest comprises telling a story about the selected points of interest.

10. The computer-implemented method of claim 9, further comprising a step (j) of receiving from the user a user input selecting at least one of a voice, a voice tone, or a vocal timbre for telling the story about the selected points of interest.

11. The computer-implemented method of claim 7, further comprising a step (k) of presenting directions to the user for navigating the vehicle to the selected point of interest.

12. The computer-implemented method of claim 11, wherein the navigating the vehicle to the selected point of interest is performed by presenting directions to the user for driving the vehicle to the selected point of interest or by self-driving the vehicle to the selected point of interest.

13. The computer-implemented method of claim 1, wherein the information about the identified points of interest is presented to the user via a Text-to-Speech (“TTS”) technology.

14. A computer program product for presenting information about a point of interest to a user of a vehicle, the computer program product being stored in a non-transitory computer-readable recording medium, wherein the computer program product is configured for:
(a) determining a current location of the vehicle;
(b) identifying one or more points of interest located within a pre-determined range from the current location of the vehicle;
(c) using an Artificial Intelligence (“AI”) model, dynamically gathering and aggregating information about the identified points of interest; and
(d) presenting to the user the information about the identified points of interest within the pre-determined range from the current location of the vehicle.

15. The computer program product of claim 14, wherein the computer program product is executed on a smartphone.

16. The computer program product of claim 14, wherein the computer program product is executed on a computer of the vehicle.

17. A vehicle comprising the computer program product of claim 14.

18. A computer-implemented method for presenting in-vehicle information to a user of a vehicle, said method comprising the steps of:
(a) obtaining data related to a current location or operation of the vehicle;
(b) using an Artificial Intelligence (“AI”) model, dynamically gathering and aggregating information about the obtained data; and
(d) presenting to the user the information about the obtained data.
